(19) United States
(12) Patent Application Publication
(10) Pub. No.: US 2015/0347210 A1
(43) Pub. Date: Dec. 3, 2015

(54) SOFTWARE LIFE EXTENSION TIME DETERMINATION SYSTEM, SOFTWARE LIFE EXTENSION TIME DETERMINATION METHOD, AND PROGRAM

(71) Applicant: Fumio Machida, Tokyo (JP)

(72) Inventor: Fumio MACHIDA, Tokyo (JP)

(73) Assignee: NEC Corporation, Tokyo (JP)

(21) Appl. No.: 14/122,148

(22) PCT Filed: Mar. 13, 2013
(86) PCT No.: PCT/JP2013/056957

§ 371 Date: Nov. 25, 2013

(30) Foreign Application Priority Data
Mar. 30, 2012 (JP) 2012-080198

(51) Int. Cl. G06F 11/00

(52) U.S. Cl. CPC G06F 11/008

(57) ABSTRACT

A software life extension time determination system includes an aging-state-model storing unit configured to store a first state model representing a state change of software due to aging of software, a software-life-extension-state-model storing unit configured to store a second state model representing a state change of the software due to software life extension processing, a parameter input unit configured to receive an input of parameter values of the first state model and the second state model, an evaluation-function storing unit configured to store an evaluation function for deciding values of performance and availability targeted by the system, a state-model analyzing unit configured to analyze the first state model and the second state model by using the parameter values and the evaluation function, and a software-life-extension-time determining unit configured to determine, on the basis of analysis results of the first state model and the second state model, whether the software life extension processing is implemented.

### BACKGROUND

The present invention relates to a software life extension time determination system, a software life extension time determination method, and a program.

A bug of software is one of main factors that cause failures of an IT system. It is difficult to completely remove bugs in development and test stages of the software. It is not rare that a system failure due to a bug of the software occurs in an operation stage.

As a typical example of the software bug that occurs in the operation stage, an aging bug is known. The aging bug is a bug in which a deterioration phenomenon occurs in an execution environment of the software because of long-term continuous operation of the software. The aging bug causes substantial performance deterioration and a system failure. For example, a bug in which memory consumption gradually increases because of long-term continuous operation and a memory leak occurs is a type of the aging bug. An example in which a value of a counter included in a program exceeds a limit value and overflows because of continuous operation for a long time can also be grasped as a type of the aging bug.

Such an aging bug is not easily found by a test of the software alone. The aging bug often becomes apparent in the operation stage of the software. Appearance of a bug after integration of the software as the IT system not only causes problems such as a system stop and performance deterioration but also makes it difficult to find and remove the bug.

As an example of measures against the aging bug during the software operation, Patent Document 1 and Patent Document 2 describe software rejuvenation.

Patent Document 1: Patent Publication JP-A-08-095814

Patent Document 2: Japanese Patent No. 3737695

The software rejuvenation described in Patent Documents 1 and 2 is a technique for preventing a failure and performance deterioration by returning an operation environment of software deteriorated by aging to an initial state through reboot or reset. Specifically, the software rejuvenation is often implemented through reboot or the like of an application server or an operating system (OS) that operates the software. A failure of the IT system due to the aging bug can be avoided or deferred by the software rejuvenation. However, since it is necessary to stop the software in an operation state once and re-operate the software, deterioration in an operating ratio of the system is caused if the software rejuvenation is unnecessarily implemented.

Therefore, it is an exemplary object of the present invention to implement an optimum response to software aging, taking into account both of availability (an operating ratio) and performance of a system.

### SUMMARY

A software life extension time determination system according to the present invention includes: an aging-state-model storing unit configured to store a first state model representing a state change of software due to aging of the software; a software-life-extension-state-model storing unit configured to store a second state model representing a state change of the software due to software life extension processing; a parameter input unit configured to receive an input of parameter values of the first state model and the second state model; an evaluation-function storing unit configured to store an evaluation function for deciding values of performance and availability targeted by the system; a state-model analyzing unit configured to analyze the first state model and the second state model by using the parameter values and the evaluation function; and a software-life-extension-time determining unit configured to determine, on the basis of analysis results of the first state model and the second state model, whether the software life extension processing is implemented.

A software life extension time determination system according to the present invention includes: an aging-state-model storing unit configured to store a first state model representing a state change of software due to aging of the software; a software-life-extension-state-model storing unit configured to store a second model representing a state change of the software due to software life extension processing; an evaluation-function storing unit configured to store an evaluation function for deciding values of performance and availability targeted by a system; a software-life-extension-determination-formula deriving unit configured to derive a software life extension determination formula on the basis of the first state model, the second state model, and the evaluation function; a parameter input unit configured to receive an input of parameter values of the first state model and the second state model; and a software-life-extension-time determining unit configured to determine, using the parameter values and the software life extension determination formula, time when the software life extension processing is implemented.

A software life extension time determination method according to the present invention includes the steps of: analyzing a first state model representing a state change of software due to aging of the software and a second state model representing a state change of the software due to software life extension processing using parameter values of the first state model and the second state model and an evaluation function for deciding values of performance and availability targeted by a system; and determining, on the basis of analysis results of the first state model and the second state model, whether the software life extension processing is implemented.

A program according to the present invention causes a computer to function as: an aging-state-model storing unit configured to store a first state model representing a state change of software due to aging of the software; a software-life-extension-state-model storing unit configured to store a second state model representing a state change of the software due to software life extension processing; a parameter input unit configured to receive an input of parameter values of the first state model and the second state model; an evaluation-function storing unit configured to store an evaluation function for deciding values of performance and availability targeted by the system; a state-model analyzing unit configured to analyze the first state model and the second state model by using the parameter values and the evaluation function; and a software-life-extension-time determining unit configured to determine, on the basis of analysis results of the first state model and the second state model, whether the software life extension processing is implemented.

According to an exemplary aspect of the present invention, it is possible to take an optimum step to respond to software aging, taking into account both of an operating ratio and performance of a system.

### DESCRIPTION OF DRAWINGS

FIG. 1 is a block diagram showing the configuration of a software life extension time determination system according to a first embodiment of the present invention.

FIG. 2 is a flowchart of the operation of the software life extension time determination system according to the first embodiment of the present invention.

FIG. 3 is a flowchart of the operation of a software life extension time determination system according to a second embodiment of the present invention.

FIG. 4 is a block diagram showing the configuration of a software life extension time determination system according to a third embodiment of the present invention.

FIG. 5 is a flowchart of the operation of the operation of the software life extension time determination system according to the third embodiment of the present invention.

FIG. 6 is a flowchart of the operation of the software life extension time determination system according to the third embodiment of the present invention.

FIG. 7 is a block diagram showing the configuration of a software life extension time determination system according to a fourth embodiment of the present invention.

FIG. 8 is a block diagram showing the configuration of a software life extension time determination system according to a fifth embodiment of the present invention.

FIG. 9 is a diagram for explaining an example of the present invention.

FIG. 10 is a diagram for explaining an example of the present invention.

FIG. 11 is a diagram for explaining an example of the present invention.

FIG. 12 is a diagram for explaining an example of the present invention.

### EXEMPLARY EMBODIMENT

### First Embodiment

Modes for carrying out the present invention are explained in detail below with reference to the drawings.

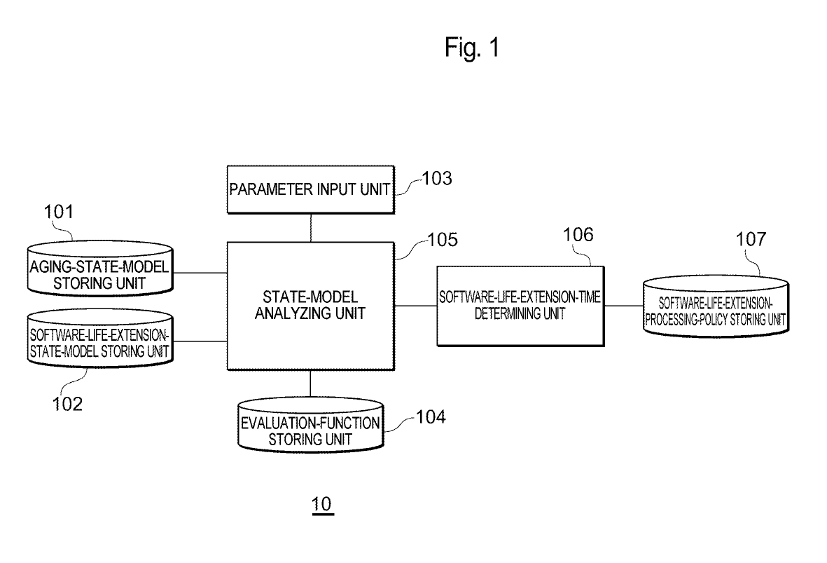

FIG. 1 is a block diagram showing the configuration of a software life extension time determination system 10 according to a first embodiment of the present invention. As shown in FIG. 1, the software life extension time determination system 10 includes an aging-state-model storing unit 101, a software-life-extension-state-model storing unit 102, a parameter input unit 103, an evaluation-function storing unit 104, a state-model analyzing unit 105, a software-life-extension-time determining unit 106, and a software-life-extension-processing-policy storing unit 107.

As the software life extension time determination system 10, a dedicated or general-purpose computer including a CPU, memories such as a ROM and a RAM, an external storage device that stores various kinds of information, an input interface, an output interface, a communication interface, and a bus connecting these devices can be applied. Note that the software life extension time determination system 10 may be configured by a single computer or may be configured by a plurality of computers connected to one another via a communication line.

The parameter input unit 103, the state-model analyzing unit 105, and the software-life-extension-time determining unit 106 are equivalent to modules of functions realized by the CPU executing a predetermined program stored in the ROM or the like. The aging-state-model storing unit 101, the software-life-extension-state-model storing unit 102, the evaluation-function storing unit 104, and the software-life-extension-processing-policy storing unit 107 are implemented by the external storage device.

The aging-state-model storing unit 101 has stored therein a model obtained by grasping a state change due to aging of software.

The software-life-extension-state-model storing unit 102 has stored therein a model obtained by grasping the behavior of software life extension processing.

The parameter input unit 103 receives an input of parameters of models of a software failure rate, a restoration rate, and the like.

The evaluation-function storing unit 104 has stored therein an evaluation function for deciding values of availability and performance targeted by a system.

The state-model analyzing unit 105 analyzes a transient state and a steady state of a state model and calculates values of the evaluation function on the basis of values of the input parameters.

The software-life-extension-time determining unit 106 determines, on the basis of a result of the model analysis, whether the software life extension processing is implemented.

The software-life-extension-processing-policy storing unit 107 stores a software life extension processing policy for retaining a result determined by the software-life-extension-time determining unit 106.

Software life extension is a method of coping with an aging bug. Whereas software rejuvenation prevents a failure and performance deterioration by returning an operation environment of software to an initial state through reboot or reset, the software life extension is a method of deferring a failure while maintaining an operation state of a system as much as possible.

For example, when an increase in memory consumption depends on a workload applied to the software, processing for reducing the workload to suppress the increase in the memory consumption and deferring time when the memory consumption reaches a memory leak is an example of the software life extension processing.

On a virtual server realized by a virtualization technique, it is possible to dynamically add a memory capacity. Therefore, deferring a failure of a memory leak through temporary addition of a memory is also an example of the software life extension processing.

Such software life extension processing can be used in a symptomatic treatment manner in operation management of a software system. However, it is desirable to systematically use the software life extension processing taking into account availability (an operating ratio) and performance of the system. That is, when the availability and the performance of the system are taken into account, it is important to determine at which point of time the software life extension processing is implemented.

Specifically, life extension processing involves costs such as a decrease in a workload processing amount and an input of additional resources. Therefore, it is inappropriate to operate the software in a degenerated state (or an over-specification state) for life extension from the beginning. On the other hand, since a failure rate of the system increases according to continuation of an operation time, it is desirable to shift to the degenerated state (or add resources) at a certain point of time. In this way, it is desirable to implement the life extension processing for the software at most effective timing from the viewpoint of availability and performance of the system.

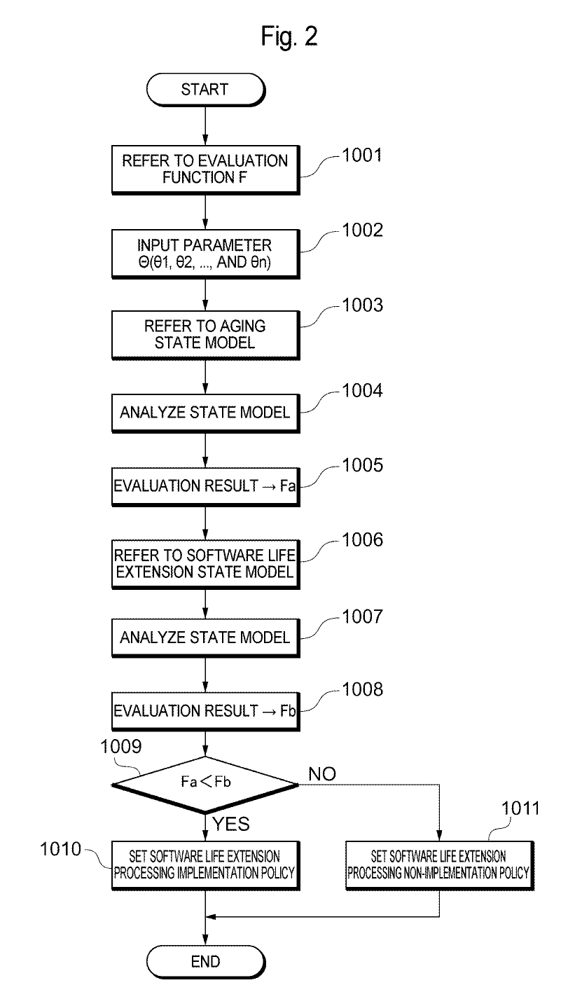

The operation of the software life extension time determination system 10 is explained with reference to FIG. 2.

First, the state-model analyzing unit 105 acquires an evaluation function F from the evaluation-function storing unit 104 (step 1001 in FIG. 2).

Subsequently, the state-model analyzing unit 105 reads parameter values necessary for an analysis via the parameter input unit 103 (step 1002). The parameter values include at least a failure rate of software, an aging rate, a restoration rate, a life extension processing execution rate, and a failure rate after life extension processing.

Subsequently, the state-model analyzing unit 105 acquires an aging state model from the aging-state-model storing unit 101 (step 1003) and performs an analysis of the state model using the input parameter values (step 1004). For example, in an analysis of a steady state, a method of directly formula-analyzing simultaneous equations, a method of numerical-analyzing the simultaneous equations according to an iterative method, and a method of analyzing the simultaneous equations according to a discrete event simulation can be applied. The state-model analyzing unit 105 calculates an evaluation function value Fa in the aging state model according to a state model analysis (step 1005).

Subsequently, the state-model analyzing unit 105 acquires a software life extension state model from the software-life-extension-state-model storing unit 102 (step 1006) and performs an analysis of the state model in the same manner as step 1004 (step 1007).

For the analysis of the state model, a method same as the method used in the analysis of the aging state model is used. The state-model analyzing unit 105 calculates an evaluation function value Fb according to the analysis (step 1008). Subsequently, the state-model analyzing unit 105 compares the evaluation function values Fa and Fb (step 1009). If Fb is larger than Fa (Yes), the state-model analyzing unit 105 determines that the software life extension processing is effective, sets a software life extension processing policy, and stores the software life extension processing policy in the software-life-extension-processing-policy storing unit 107 (step 1010).

When a smaller evaluation function value F is desirable, if Fb is smaller than Fa, the state-model analyzing unit 105 determines that the software life extension processing is effective. When the software life extension processing is not effective, the state-model analyzing unit 105 does not implement the software life extension processing (step 1011).

As explained above, according to this embodiment, the state-model analyzing unit 105 determines, on the basis of a comparison result of the state model analysis result Fa of the aging state model and the state model analysis result Fb of the software life extension state model, whether the software life extension is performed. Therefore, it is possible to determine whether the software life extension processing is effective from the viewpoint of availability (an operating ratio) and performance of the system.

### Second Embodiment

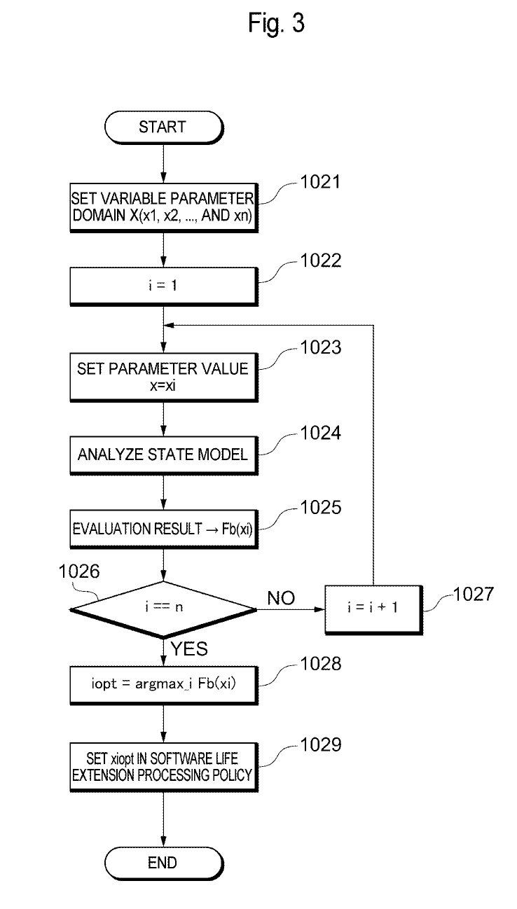

FIG. 3 is a flowchart of the operation of the software life extension time determination system 10 according to a second embodiment of the present invention.

In the second embodiment, first, the state-model analyzing unit 105 reads, via the parameter input unit 103, a domain X=(x1, x2, . . . , and xn) of variable parameters representing a life extension time (step 1021). Examples of the variable parameters include a software life extension execution rate (the number of times of software life extension processing execution per unit time) and an average software life extension processing implementation interval.

Subsequently, the state-model analyzing unit 105 sets parameter values xi (1≦i≦n) in order in a range of the input domain X and derives evaluation function values Fb(xi) according to a state model analysis (steps 1023 to 1025). The state-model analyzing unit 105 repeats steps 1023 to 1025 concerning all the parameter values xi in the domain X (steps 1026 and 1027).

When the evaluation function values Fb(xi) are derived concerning all the parameter values xi, the state-model analyzing unit 105 calculates xi with which an evaluation function value is maximized and sets a value of i at this point as iopt (step 1028). Further, the state-model analyzing unit 105 sets a software life extension processing policy for executing software life extension processing on the basis of xiopt (step 1029).

For example, when the parameter xi represents a software life extension processing execution rate, the state-model analyzing unit 105 calculates an average software life extension processing execution interval from an inverse of the rate and sets, on the basis of the execution interval, a policy for executing the software life extension processing.

As explained above, according to this embodiment, the optimum parameter value xiopt for maximizing or minimizing a target index is calculated from the domain of the variable parameters representing the life extension time according to the state model analysis and the software life extension processing is implemented. Therefore, it is possible to determine a software life extension processing time for optimizing availability and performance of a system.

### Third Embodiment

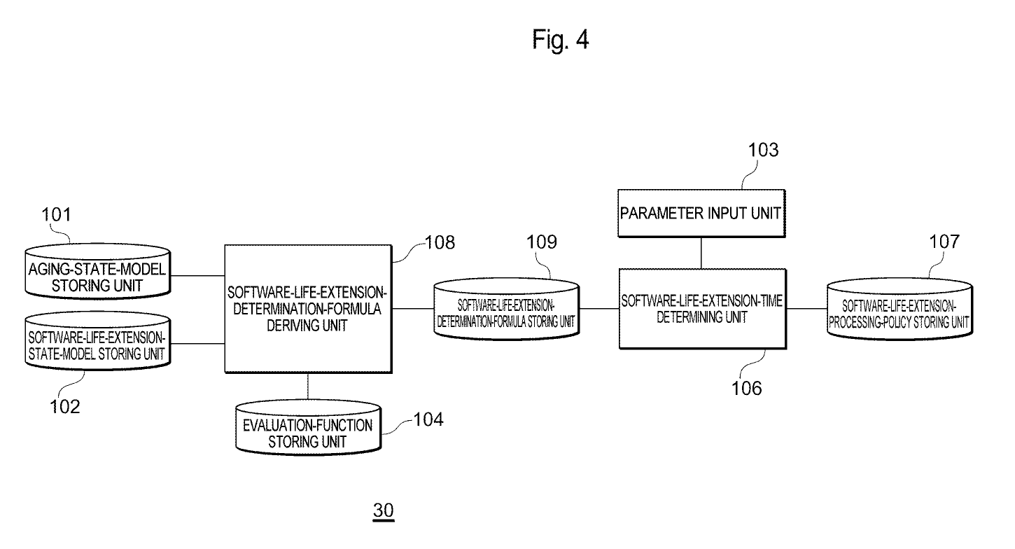

FIG. 4 is a block diagram showing the configuration of a software life extension time determination system 30 according to a third embodiment of the present invention. Reference numerals same as those in FIG. 1 denote the same components.

As shown in FIG. 4, the software life extension time determination system 30 is different from the first embodiment in that the software life extension time determination system 30 includes a software-life-extension-determination-formula deriving unit 108 and a software-life-extension-determination-formula storing unit 109.

The software-life-extension-determination-formula deriving unit 108 derives a software life extension determination formula beforehand on the basis of an aging state model acquired from the aging state model 101, a software life extension state model acquired from the software-life-extension-state-model storing unit 102, and an evaluation function acquired from the evaluation-function storing unit 104 and stores the software life extension determination formula in the software-life-extension-determination-formula storing unit 109. The software-life-extension-time determining unit 106 determines a software life extension time on the basis of parameter values read via the parameter input unit 103 and the software life extension determination formula acquired from the software-life-extension-determination-formula storing unit 109.

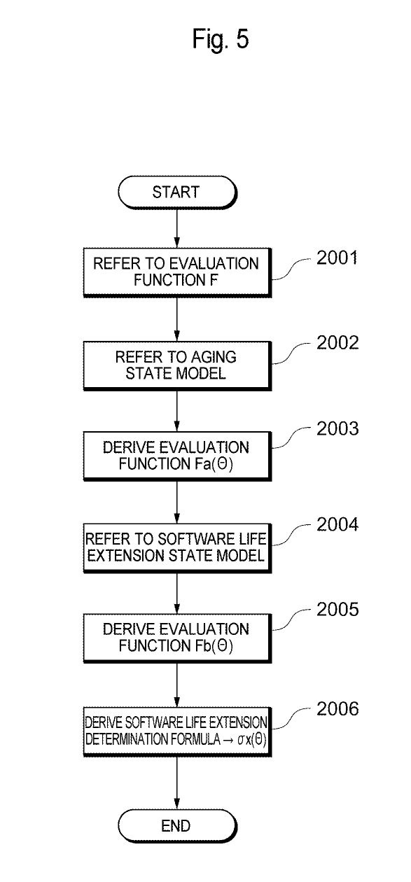

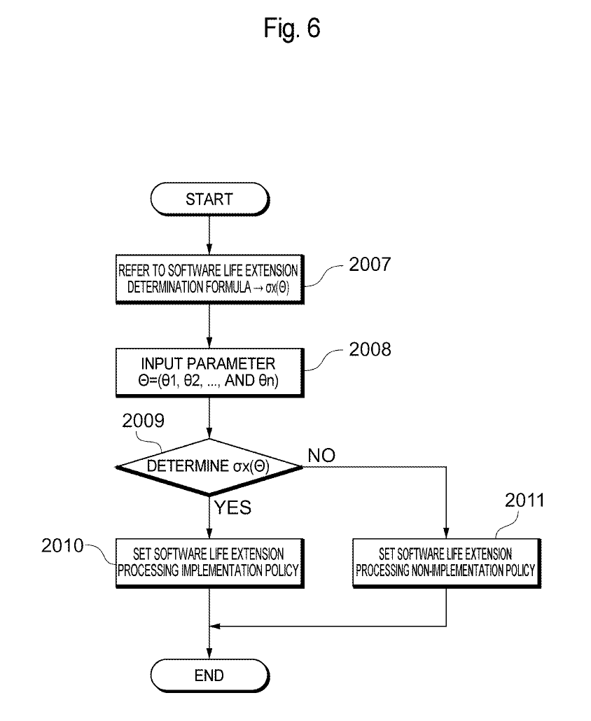

The operation of the software life extension time determination system 30 is explained with reference to FIGS. 5 and 6.

First, the software-life-extension-determination-formula deriving unit 108 acquires the evaluation function F from the evaluation-function storing unit 104 (step 2001 in FIG. 5) and acquires an aging state model from the aging-state-model storing unit 101 (step 2002).

Subsequently, the software-life-extension-determination-formula deriving unit 108 derives an evaluation function in the aging state model according to a formula analysis (step 2003). The evaluation function is represented as a function Fa(Θ) of an input parameter Θ=(θ1, θ2, . . . , and θn).

Subsequently, the software-life-extension-determination-formula deriving unit 108 acquires a software life extension state model from the software-life-extension-state-model storing unit 102 (step 2004) and derives an analysis result Fb(Θ) of the evaluation function in the same manner as step 2003 (step 2005).

Subsequently, the software-life-extension-determination-formula deriving unit 108 compares Fa(Θ) and Fb(Θ), derives a condition σx(Θ) concerning Θ with which Fa(Θ)<Fb(Θ), and stores the condition σx(Θ) in the software-life-extension-determination-formula storing unit 109 (step 2006).

The processing explained above can also be performed beforehand even before the software life extension processing time is determined, that is, when parameter values are unknown.

Subsequently, when it is necessary to determine effectiveness of life extension processing, the software-life-extension-time determining unit 106 refers to the software life extension determination formula σx(Θ) (step 2007 in FIG. 6).

Subsequently, the software-life-extension-time determining unit 106 reads parameter values via the parameter input unit 103 (step 2008), inputs the parameter values to the determination formula σx(Θ), and performs the determination (step 2009).

If the condition Fa(Θ)<Fb(Θ) is satisfied as a result of the determination, the software-life-extension-time determining unit 106 sets a software life extension processing implementation policy (step 2010). If the condition is not satisfied, the software-life-extension-time determining unit 106 does not implement the life extension processing (step 2011).

As explained above, according to this embodiment, the conditions for enabling the software life extension processing and the conditions concerning the parameter values for implementing optimum life extension processing are derived beforehand by the formula analysis and stored. Therefore, when effectiveness of the life extension processing is determined, since the determination can be performed if the parameter values are given, it is possible to simplify the determination processing. In this embodiment, since effectiveness of the life extension processing can be determined only with the parameter values, it is possible to reuse the derived determination formula as a determination standard in various systems.

### Fourth Embodiment

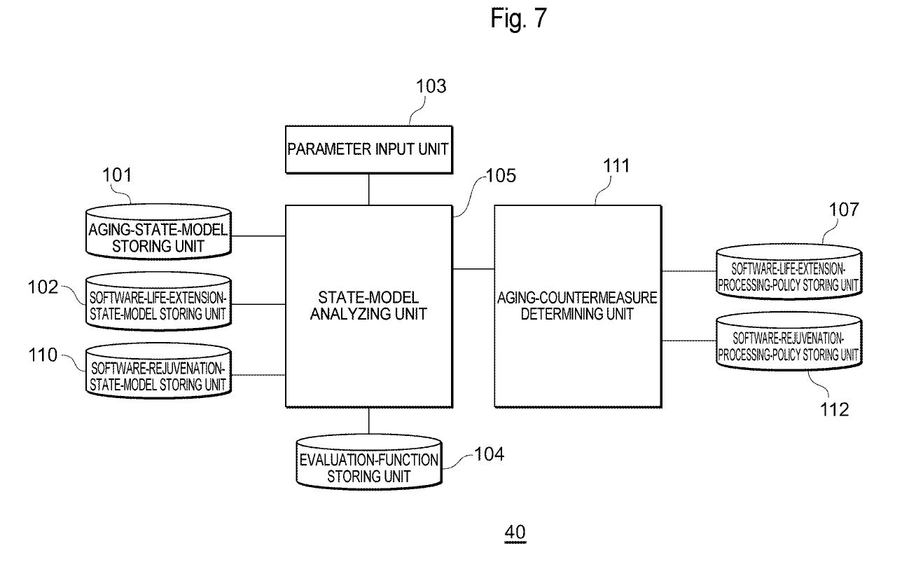

FIG. 7 is a block diagram showing the configuration of a software life extension time determination system 40 according to a fourth embodiment of the present invention. Reference numerals same as those in FIG. 1 denote the same components.

As shown in FIG. 7, the software life extension time determination system 40 is different from the first embodiment in that the software life extension time determination system 40 includes a software-rejuvenation-state-model storing unit 110, an aging-countermeasure determining unit 111, and a software-rejuvenation-processing-policy storing unit 112.

The operation of the software life extension time determination system 40 according to the fourth embodiment is explained.

The state-model analyzing unit 105 derives the evaluation functions Fa and Fb using an aging state model and a software life extension state model as in the first embodiment. Further, the state-model analyzing unit 105 acquires a software rejuvenation state model from the software-rejuvenation-state-model storing unit 110 and derives a value Fc of the evaluation function F on the basis of input parameters.

Further, as in step 1009 in FIG. 2, the aging-countermeasure determining unit 111 determines, from an evaluation of a magnitude relation of Fa, Fb, and Fc, whether software life extension is implemented, software rejuvenation is implemented, or both of the software life extension and the software rejuvenation are not implemented. Depending on a state of a system, it is more effective to implement the software rejuvenation than the software life extension processing.

As explained above, according to this embodiment, effective means for coping with software aging is determined taking into account the software rejuvenation state model as well. Therefore, it is possible to determine a more effective aging countermeasure in terms of availability and performance of a system.

### Fifth Embodiment

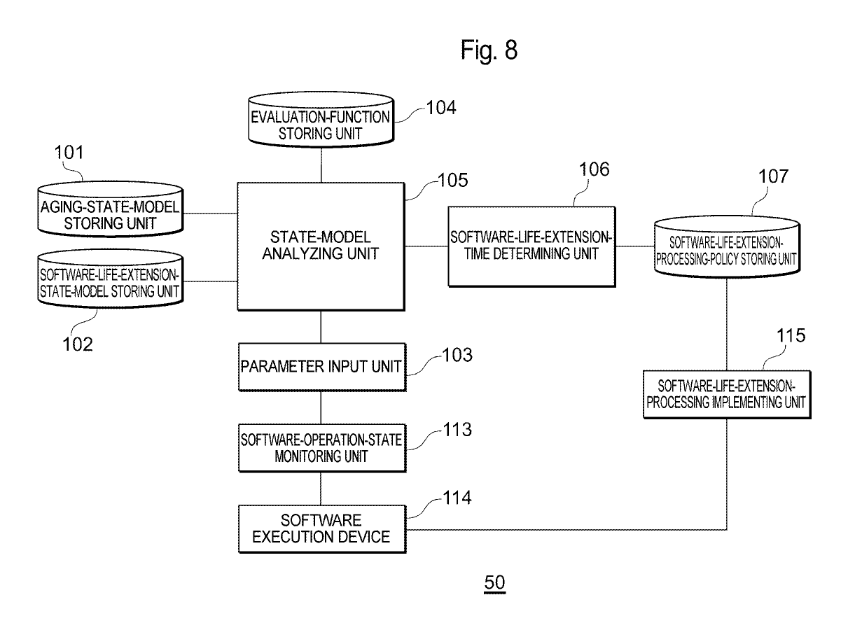

FIG. 8 is a block diagram showing the configuration of a software life extension time determination system 50 according to a fifth embodiment of the present invention. Reference numerals same as those in FIG. 1 denote the same components.

As shown in FIG. 8, the software life extension time determination system 50 is different from the first embodiment in that the software life extension time determination system 50 includes a software-operation-state monitoring unit 113, a software execution device 114, and a software-life-extension-processing implementing unit 115.

The software execution device 114 is a device that executes software in which a deterioration phenomenon due to aging occurs. The software-operation-state monitoring unit 113 monitors an operation state of the software in the software execution device 114.

The software-operation-state monitoring unit 113 determines parameter values input to a model from statistics of monitoring information and supplies the parameter values to the parameter input unit 103.

On the other hand, the software-life-extension-processing implementing unit 115 refers to a software life extension processing policy set by the software-life-extension-time determining unit 106 and implements software life extension processing for the software execution device 114 at timing designated by the policy. Specifically, the software life extension processing includes a reduction in a load applied to software and a work load, dynamic addition of resources, and shift to a designated degeneration configuration.

As explained above, according to this embodiment, parameter values are determined on the basis of monitoring information of operating software and propriety of implementation of the software life extension processing is determined. Therefore, it is possible to dynamically determine effectiveness of the software life extension processing according to an operation state.

### EXAMPLES

Examples of the present invention are explained using specific examples.

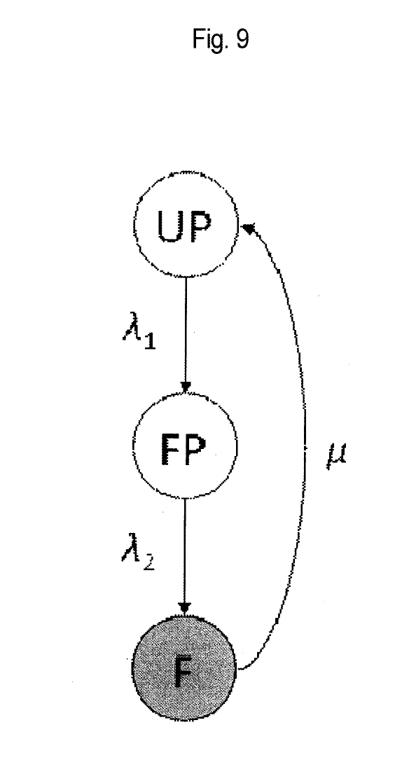

FIG. 9 is an example in which a software aging state model is represented using a continuous-time Markov chain (CTMC). Circles in the figure represent states and arrows in the figure represent transition paths of the states. Time required for transitions of the states conforms to an exponential distribution having labeled values as parameter values.

A state UP represents a normal operation state of software. A state FP represents a state in which the software is deteriorated by software aging. A state F represents a state in which a software failure occurs according to progress of the aging.

The software transitions from the state UP to the state FP at a rate of λ1, transitions from the state FP to the state F at a rate of λ2, and transitions from the state F to the state UP at a rate of μ. Parameter values representing rates such as λ1, λ2, and μ are equivalent to an inverse of an average transition time and can be calculated from a software average aging state transition time, an average failure time, and an average restoration time.

For example, when it is assumed that time required until the software returns to the normal operation states after a failure is two hours in average, μ=½ (a unit is [1/hour]). In this model, the state UP and the state FP are software operation states.

Therefore, availability of the system is represented by a sum of a probability that the software is in the state UP and a probability that the software is in the state FP. If a probability of the state UP in a steady state is represented as πUP and a probability of the state FP is represented as πFP, availability A_{N} is calculated as πUP+πFP. Values of πUP and πFP can be calculated by a steady state analysis of the CTMC.

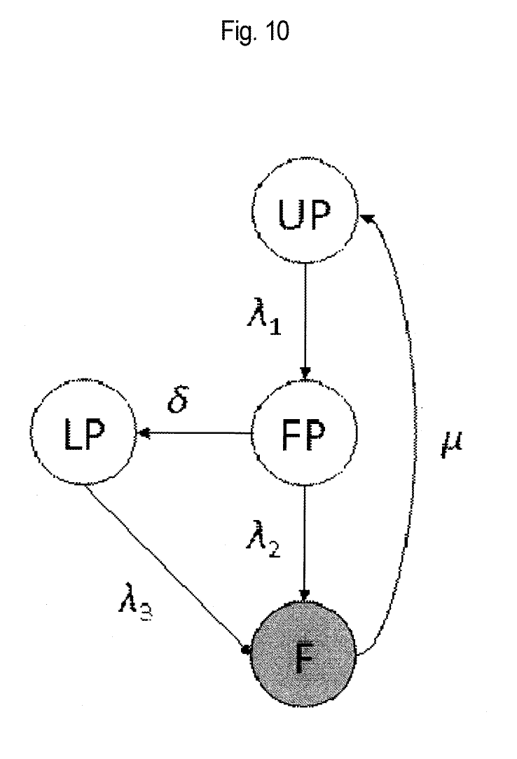

FIG. 10 is a diagram showing an example in which the behavior of the software life extension processing is modeled by the CTMC. The behavior of the software life extension processing includes a state LP after the implementation of the life extension processing in addition to the CTMC of the software aging state model. The software transitions from the state FP to the state LP at a rate of δ and finally transitions to the state F at a rate of λ3 according to the software life extension processing.

Since the state LP is also one of the software operation states, availability A_{L} of the system is calculated as πUP+πFP+πLP. However, values of πUP and πFP are different from the values of πUP and πFP of the software aging state model.

As an analysis method for the steady state of the CTMC, there is a method of analytically solving a state equation, a method of solving the state equation according to an iterative method, and a method of solving the state equation according to a discrete time simulation. An example of the method of analytically solving the state equation is explained here. When the steady state is analyzed according to an expression analysis concerning the CTMC shown in FIG. 9 and the CTMC shown in FIG. 10, A_{N} and A_{L} are respectively calculated as indicated by the following Expressions 1 and 2:

$$\begin{matrix}[ Math . 1 ] & \\ {A}_{N} = \frac{( {λ}_{1} + {λ}_{2} ) \cdot μ}{( {λ}_{1} + {λ}_{2} ) \cdot μ + {λ}_{1} {λ}_{2}} ; \\ and & ( Expression 1 ) \\ [ Math . 2 ] & \\ {A}_{L} = \frac{{μλ}_{3} \cdot ( {λ}_{1} + {λ}_{2} + δ ) + {λ}_{1} μδ}{{μλ}_{3} \cdot ( {λ}_{1} + {λ}_{2} + δ ) + {λ}_{1} {λ}_{3} \cdot ( {λ}_{2} + δ ) + {λ}_{1} μδ} . & ( Expression 2 )\end{matrix}$$

When λ1=1/(24*20), λ2=1/(24*10), λ3=1/(24*15), δ= 1/24, and m=1 are input as parameter values, A_{N} and A_{L} are calculated as A_{N}=0.998613 and A_{L}=0.998795.

As a result, since A_{N}<A_{L}, it can be determined that the software life extension processing is effective in terms of availability.

A situation in which there are δ1= 1/12, δ2= 1/24, and δ3= 1/48 as candidates of the software life extension processing execution rate δ is considered. When the parameter values are changed and availability is evaluated, A_{L}(δ1)=0.998803, A_{L}(δ2)=0.998795, and A_{L}(δ3)=0.998782 are obtained. It is seen that the availability is the highest when the life extension processing execution rate is δ1. Therefore, the availability can be maximized by setting a policy for implementing the life extension processing at the life extension processing execution rate of δ1.

Subsequently, a condition in which the software life extension processing is enabled is considered. The software life extension processing is enabled in terms of availability when A_{L}≧A_{N} is satisfied. When Expressions 1 and 2 are applied to this condition and rearranged, the expressions are calculated as being equivalent to a condition λ3≦λ2. If this condition is used as the software life extension determination formula, the condition can be used as a standard of determination for implementing the software life extension processing in various situations.

λ3≦λ2 represents that a software failure rate after the life extension processing is small compared with a failure rate obtained when the life extension processing is not implemented and coincides with intuitive determination. For example, when a model representing software aging and a model representing the life extension processing are more complicated or when the evaluation function includes performance and costs, the software failure rate cannot always be intuitively determined.

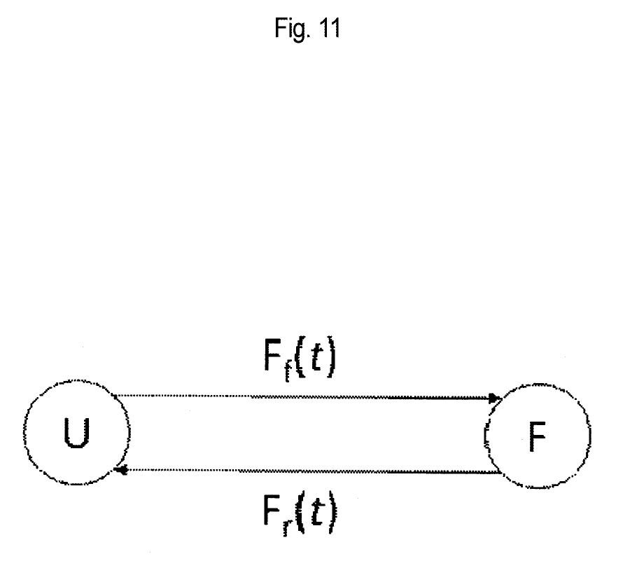

FIG. 11 is an example in which a state transition of software aging is modeled by a semi-Markov process (SMP). A state U represents an operation state and a state F represents a software failure state. A state transition time from the state U to the state F conforms to a probability distribution F_{f}(t). A state transition time representing restoration from the state F to the state U conforms to a probability distribution Fᵣ(t).

A failure rate of a failure of software gradually increases according to aging. Therefore, a probability distribution of a type in which a failure rate increases according to the elapse of time is used (e.g., a hypo-exponential distribution). The availability of this system is represented by a probability that the software is in the state U in the steady state. The availability can be calculated by the following expression:

$$\begin{matrix}[ Math . 3 ] & \\ {A}_{N} = \frac{{\int }_{0}^{∞} [ 1 - {F}_{f} ( t ) ] d t}{{\int }_{0}^{∞} [ 1 - {F}_{f} ( t ) ] d t + {\int }_{0}^{∞} [ 1 - {F}_{r} ( t ) ] d t} . & ( Expression 3 )\end{matrix}$$

It is considered that an aging state is not specified and the software life extension processing is implemented when a fixed time T elapses after the software operates. Since it is unnecessary to specify an aging state, implementation of the software life extension processing is easy. However, it is difficult to determine an appropriate life extension processing implementation time.

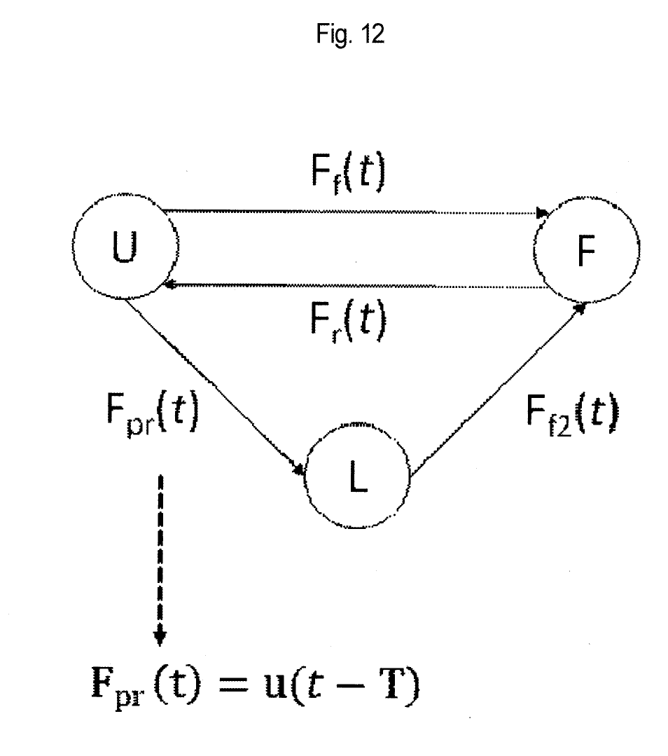

FIG. 12 is a diagram showing an example in which the behavior of this system is modeled by the SMP. The model shown in FIG. 12 includes a state L after the implementation of the software life extension processing in addition to the SMP model of software aging. A state transition time from the state U to the state L conforms to a probability distribution Fₚᵣ(t). A state transition time from the state L to the state F conforms to a probability distribution F_{f2}(t). It is assumed that transition from the state U to the state L is definitive and represented as u(t−T) using a unit step function u(t). That is, when it is considered that a state transition definitively occurs at time t=T, availability in this system is represented by a probability that the software is in the state U or in the state L. Therefore, the availability can be calculated by the following expression:

$$\begin{matrix}[ Math . 4 ] & \\ {A}_{L} = \frac{{h}_{0} + ( 1 - {F}_{f} ( T ) ) {h}_{1}}{{h}_{0} + ( 1 - {F}_{f} ( T ) ) {h}_{1} + {h}_{2}} \\ {h}_{0} = {\int }_{0}^{T} [ 1 - {F}_{f} ( t ) ] d t \\ {h}_{1} = {\int }_{0}^{∞} [ 1 - {F}_{{f}_{2}} ( t ) ] d t \\ {h}_{2} = {\int }_{0}^{∞} [ 1 - {F}_{r} ( t ) ] d t . & ( Expression 4 )\end{matrix}$$

Specific probability distributions are assumed for F_{f}(t), Fᵣ(t), and F_{f2}(t) and given parameter input values are given to the model to evaluate Expressions 3 and 4. Consequently, it is possible to determine whether the software life extension processing is effective. If availability is evaluated by changing a value of T, it is possible to specify T that maximizes the availability. In particular, when conditions of the following Expression 5 are satisfied, there is Topt that maximizes the availability in a range of 0<T<∞. In this case, Topt is calculated as a value satisfying the following Expression 6:

$$\begin{matrix}[ Math . 5 ] & \\ {r}_{f} ( T ) = \frac{\frac{d {F}_{f} ( T )}{d T}}{1 - {F}_{f} ( T )} , \\ \frac{d {r}_{f} ( T )}{d T} > 0 \\ and \\ {r}_{f} ( 0 ) < \frac{1}{{h}_{1}} < {r}_{f} ( ∞ ) ; & ( Expression 5 ) \\ [ Math . 6 ] & \\ {r}_{f} ( {T}_{opt} ) = \frac{1}{{h}_{1}} . & ( Expression 6 )\end{matrix}$$

This application claims priority based on Japanese Patent Application No. 2012-80198 filed on Mar. 30, 2012, the entire contents of which are incorporated herein.

The present invention is explained above with reference to the embodiments. However, the present invention is not limited to the embodiments. Various changes that those skilled in the art could understand can be made to the configurations and the details of the present invention within the scope of the present invention.

A part or all of the embodiments explained above can be also be described as indicated by the following notes but are not limited to the below.

(Note 1) A software life extension time determination system comprising:

an aging-state-model storing unit configured to store a first state model representing a state change of software due to aging of the software;

a software-life-extension-state-model storing unit configured to store a second state model representing a state change of the software due to software life extension processing;

a parameter input unit configured to receive an input of parameter values of the first state model and the second state model;

an evaluation-function storing unit configured to store an evaluation function for deciding values of performance and availability targeted by the system;

a state-model analyzing unit configured to analyze the first state model and the second state model by using the parameter values and the evaluation function; and

a software-life-extension-time determining unit configured to determine, on the basis of analysis results of the first state model and the second state model, whether the software life extension processing is implemented.

(Note 2) A software life extension time determination system comprising:

an aging-state-model storing unit configured to store a first state model representing a state change of software due to aging of the software;

a software-life-extension-state-model storing unit configured to store a second state model representing a state change of the software due to software life extension processing;

an evaluation-function storing unit configured to store an evaluation function for deciding values of performance and availability targeted by the system;

a software-life-extension-determination-formula deriving unit configured to derive a software life extension determination formula on the basis of the first state model, the second state model, and the evaluation function;

a parameter input unit configured to receive an input of parameter values of the first state model and the second state model; and

a software-life-extension-time determining unit configured to determine, by using the parameter values and the software life extension determination formula, time when the software life extension processing is implemented.

(Note 3) The software life extension time determination system according to note 1, wherein the state-model analyzing unit further analyzes, by using the parameter values and the evaluation function, a third state model representing a state change of the software due to software rejuvenation processing,

the software life extension time determination system further comprising an aging-countermeasure determining unit configured to determine, on the basis of analysis results of the first state model, the second state model, and the third state model, whether the software life extension processing or the software rejuvenation is implemented.

(Note 4) The software life extension time determination system according to any one of notes 1 to 3, further comprising:

a software execution device configured to execute the software;

a software-operation-state monitoring unit configured to monitor an operation state of the software in the software execution device and determine the parameter values on the basis of the operation state; and

a software-life-extension-processing implementing unit configured to implement, for the software execution device, software life extension processing determined by the software life extension time determination system.

(Note 5) A software life extension time determination method:

a step of implementing analysis using a first state model representing a state change of software due to aging of the software, a second state model representing a state change of the software due to software life extension processing, parameter values of the first state model and the second state model, and an evaluation function for deciding values of performance and availability targeted by the system; and

a step of determining, on the basis of analysis results of the first state model and the second state model, whether the software life extension processing is implemented.

(Note 6) A program for causing a computer to function as:

an aging-state-model storing unit configured to store a first state model representing a state change of software due to aging of the software;

a software-life-extension-state-model storing unit configured to store a second state model representing a state change of the software due to software life extension processing;

a parameter input unit configured to receive an input of parameter values of the first state model and the second state model;

an evaluation-function storing unit configured to store an evaluation function for deciding values of performance and availability targeted by a system;

a state-model analyzing unit configured to analyze the first state model and the second state model by using the parameter values and the evaluation function; and

a software-life-extension-time determining unit configured to determine, on the basis of analysis results of the first state model and the second state model, whether the software life extension processing is implemented.

The present invention can be applied to a highly reliable design tool of a system for continuously operating software for a long period. The present invention can also be applied to a system management tool for monitoring an operation state of software and implementing appropriate management operation.
10, 30, 40, 50 Software life extension time determination systems
101 Aging-state-model storing unit
102 Software-life-extension-state-model storing unit
103 Parameter input unit
104 Evaluation-function storing unit
105 State-model analyzing unit
106 Software-life-extension-time determining unit
107 Software-life-extension-processing-policy storing unit
108 Software-life-extension-determination-formula deriving unit
109 Software-life-extension-determination-formula storing unit
110 Software-rejuvenation-state-model storing unit
111 Aging-countermeasure determining unit
112 Software-rejuvenation-processing-policy storing unit
113 Software-operation-state monitoring unit
114 Software execution device
115 Software-life-extension-processing implementing unit

1. A software life extension time determination system comprising:
an aging-state-model storing unit configured to store a first state model representing a state change of software due to aging of the software;
a software-life-extension-state-model storing unit configured to store a second state model representing a state change of the software due to software life extension processing;
a parameter input unit configured to receive an input of parameter values of the first state model and the second state model;
an evaluation-function storing unit configured to store an evaluation function for deciding values of performance and availability targeted by the system;
a state-model analyzing unit configured to analyze the first state model and the second state model by using the parameter values and the evaluation function; and
a software-life-extension-time determining unit configured to determine, on the basis of analysis results of the first state model and the second state model, whether the software life extension processing is implemented.

2. A software life extension time determination system comprising:
an aging-state-model storing unit configured to store a first state model representing a state change of software due to aging of the software;
a software-life-extension-state-model storing unit configured to store a second state model representing a state change of the software due to software life extension processing;
an evaluation-function storing unit configured to store an evaluation function for deciding values of performance and availability targeted by the system;
a software-life-extension-determination-formula deriving unit configured to derive a software life extension determination formula on the basis of the first state model, the second state model, and the evaluation function;
a parameter input unit configured to receive an input of parameter values of the first state model and the second state model; and
a software-life-extension-time determining unit configured to determine, by using the parameter values and the software life extension determination formula, time when the software life extension processing is implemented.

3. The software life extension time determination system according to claim 1, wherein the state-model analyzing unit further analyzes, by using the parameter values and the evaluation function, a third state model representing a state change of the software due to software rejuvenation processing,
the software life extension time determination system further comprising an aging-countermeasure determining unit configured to determine, on the basis of analysis results of the first state model, the second state model, and the third state model, whether the software life extension processing or the software rejuvenation is implemented.

4. The software life extension time determination system according to claim 1, further comprising:
a software execution device configured to execute the software;
a software-operation-state monitoring unit configured to monitor an operation state of the software in the software execution device and determine the parameter values on the basis of the operation state; and
a software-life-extension-processing implementing unit configured to implement, for the software execution device, software life extension processing determined by the software life extension time determination system.

5. A software life extension time determination method comprising:
a step of implementing analysis using a first state model representing a state change of software due to aging of the software, a second state model representing a state change of the software due to software life extension processing, parameter values of the first state model and the second state model, and an evaluation function for deciding values of performance and availability targeted by the system; and
determining, on the basis of analysis results of the first state model and the second state model, whether the software life extension processing is implemented.

6. A program for causing a computer to function as:
an aging-state-model storing unit configured to store a first state model representing a state change of software due to aging of the software;
a software-life-extension-state-model storing unit configured to store a second state model representing a state change of the software due to software life extension processing;
a parameter input unit configured to receive an input of parameter values of the first state model and the second state model;
an evaluation-function storing unit configured to store an evaluation function for deciding values of performance and availability targeted by a system;
a state-model analyzing unit configured to analyze the first state model and the second state model by using the parameter values and the evaluation function; and
a software-life-extension-time determining unit configured to determine, on the basis of analysis results of the first state model and the second state model, whether the software life extension processing is implemented.
